(19) United States
(12) Patent Application Publication
(10) Pub. No.: US 2025/0072645 A1
(43) Pub. Date: Mar. 6, 2025

(54) DUAL ACTION FRUIT STEM REMOVAL APPARATUS

(71) Applicant: DAXO Industries, Inc., Philadelphia, PA (US)

(72) Inventor: Jiahao Zhang, Philadelphia, PA (US)

(73) Assignee: DAXO Industries, Inc., Philadelphia, PA (US)

(21) Appl. No.: 18/586,853

(22) Filed: Feb. 26, 2024

Related U.S. Application Data
(63) Continuation-in-part of application No. 18/459,333, filed on Aug. 31, 2023.

(51) Int. Cl. A47J 21/00

(52) U.S. Cl. CPC A47J 21/00

(57) ABSTRACT

A dual action fruit stem removal apparatus that enables hands free fruit stem clipping of stems from two fruits simultaneously. The fruit stem removal apparatus includes an elongated base with a flexible cutting device disposed at first and second ends thereof which are configured to flexibly force a cutting blade against a stop block to cut a stem from a piece of fruit when the stem is inserted between the cutting blade and stop block of each cutting device.

### STATEMENT REGARDING FEDERALLY SPONSORED RESEARCH OR DEVELOPMENT

Not applicable

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71 (d).

### BACKGROUND OF THE INVENTIVE CONCEPT

### Field of the Invention

The present inventive concept relates to a fruit stem removal apparatus. More particularly, but not exclusively, this inventive concept relates to a fruit stem removal apparatus that enables hands free fruit stem clipping of all types of fruits to improve efficiency of fruit picking processes.

### Description of the Related Art

As fruit pickers walk through orchards and other areas where fruits grow they are required to pick the fruits from the trees or bushes with their hands. After the fruit is picked from the tree or bush, the stems of these picked fruits must be removed for further processing of the fruit and to prevent fruit damage from stem punctures during storage and packaging of the fruit. There are many different types of stem removal devices on the market. However, most stem removal devices require being held in one hand of the picker while the other hand of the picker picks the fruit. Moreover, in order to clip the stems from the picked fruit the picker must hand the fruit in one hand and remove the stem with the other hand. This process requires time for the picker to stop picking fruit from the tree/bush to remove the stems and place the de-stemmed fruit in a bag before picking another fruit from the tree/bush. Conventional stem removal devices are described below.

U.S. Pat. No. 5,857,316 by Murdock discloses a manual stem cutting and fruit removal apparatus 10. This apparatus 10 includes a receptacle member 12 having a mouth 16 and a cutting assembly 19. The cutting assembly 19 includes a blade holder 42 and a pair of blades 40 formed in a Y-shape. Here a piece of fruit must be inserted into the receptable member 12 and then slid to a position beneath the cutting assembly 19. Then a forceful backward motion of the apparatus 10 is required to force a stem of the fruit between the two blades 40 to sever the stem from the fruit. This apparatus 10 is large and bulky, and requires a significant number of steps to capture a piece of fruit and remove the stem. Moreover, two hands are required to hold this apparatus 10 up to a piece of fruit on a tree and forcefully pull the entire apparatus 10, by its handle 15, in a backward direction to remove the stem.

U.S. Pat. No. 3,857,227 by Rosenberg discloses a cutter head for picking fruit on a tree. This cutter 10 is supported on an elongated rod 11. The cutter head 10 includes a pair of overlying plates 12 and 13 disposed in an overlying relationship (see FIGS. 1 and 2) and a cutter 18 including a pair of cutter bars 35. The cutter 10 is actuated by squeezing either an actuator mechanism 17 or 20, both disposed along the elongated rod 11. This device requires both hands to grip the rod 11 and/or the actuator mechanisms 17 or 20 while the cutter 10 is raised up to insert a stem of a fruit between the cutter bars 35. When the actuator(s) 17 or 20 are squeezed the cutter bars 35 are pivoted toward each other to cut the stem. With this device both hands are required to raise the cutter 10 up to a piece of fruit while one hand operates an actuator 17 to cut the stem of a fruit.

U.S. Pat. No. 2,206,790 by Read et al. discloses a cutter for picking fruit. Here the cutter requires one finger of each hand of a picker to be inserted through loops 12, 35, respectively. Once the fingers of opposite hands are inserted through the loops 12, 35 the loops 12, 35 must be pushed together to move opposing blades 21, 33 toward each other while a stem is positioned therebetween. The loop and blade pairs 12, 21 and 33, 35 are held together by screws 30, 31 inserted into elongated slots 26, 27, respectively. With this device both hands are required to insert a stem between blades 21, 33 and then slide the blade 21, 33 toward each other while both hands are occupied by fingers being inserted into the loops 12, 35.

JP 5839384B2 discloses a fruit stem cutter 1 including a pair of blade parts 2 which pivot around a pair of parallel support shafts 20 while blade edges 22 face each other. Stopper parts 3 are positioned to support the blade edges 22 such that the opening between the blade edges 22, 22a is just larger than the diameter of a fruit stem. The fruit stem is inserted between the pair of blade edges 22, 22a and then the fruit stem is pulled upward such that the pair of blade parts 2 turn upward to cut the fruit stem. Here one hand of a user must hold the fruit below the blade parts 2, insert the stem of the fruit between the blade edges 22, 22a and then a second hand of the user is required to grab the stem and pull it upward to move the blades edges 22, 22a together to cut the stem.

Accordingly, there is a need for a fruit stem removal apparatus that enables hands-free fruit stem clipping.

There is also a need for a fruit stem removal apparatus that improves efficiency of clipping stems from fruit.

There is also a need for a fruit stem removal apparatus that enables a fruit picker to remove a stem from one piece of fruit while simultaneously picking another piece of fruit off a tree or bush.

There is also a need for a fruit stem removal apparatus that requires only one step to remove a stem from a piece of fruit.

There is also a need for a fruit stem removal apparatus that enables a user to simultaneously, or in rapid succession, cut stems off two pieces of fruit for time conservation purposes for improved productivity.

### SUMMARY OF THE INVENTIVE CONCEPT

The present general inventive concept provides a fruit stem removal apparatus that enables hands free fruit stem clipping of all types of fruits to improve efficiency of fruit picking processes.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a fruit stem removal apparatus, comprising: an elongated base including a first end and a second end and an upward extending wall along one side thereof, the wall including an arm support extending from a top portion thereof over the elongated base; a flexible center arm connected to the arm support such that the center arm is disposed above and in parallel with the elongated base, a first end of the flexible center arm including a first blade extending therefrom and a second end of the center arm including a first stop block attached thereto to receive an end of a blade; a flexible stop block arm attached at a first end to the first end of the elongated base such that the flexible stop block arm extends at an angle upwards towards the blade attached to the flexible center arm, the stop block arm including a second stop block to receive an end of the first blade extending from the flexible center arm when the flexible stop block arm and flexible center arm are pressed downward toward the base; and a flexible blade arm attached at a first end thereof to the second end of the base such that the flexible blade arm extends at an angle upwards toward the first stop block attached to the second end of the center arm, the blade arm including a second blade extending therefrom which becomes pressed against the first stop block attached to the center arm when the flexible blade arm and the flexible center arm are pressed downward toward the base.

In an exemplary embodiment the fruit stem removal apparatus may further comprise a first blade mouthpiece attached to the first end of the center arm, the first blade mouthpiece including the first blade extending therefrom; a first stop block mouthpiece attached to the second end of center arm, the first stop block mouthpiece including the first stop block formed thereon; a second stop block mouthpiece attached to the second end of the flexible stop block arm and including the second stop block disposed thereon; and a second blade mouthpiece attached to the second end of the flexible blade arm, the second blade mouthpiece including the second blade extending therefrom.

In another exemplary embodiment the center arm may include a connection groove and a connection insert hole formed therethrough at the first and second ends thereof; the flexible blade arm and the flexible stop block arm include a connection groove and a connection insert hole formed therein; and the first and second blade mouthpieces and the first and second stop block mouthpieces each include a groove post and an insert post to be inserted into respective ones of the connection grooves and connection insert holes of the flexible blade arm, the flexible stop block arm and the first and second ends of the flexible center arm, respectively, such that after the groove posts and insert posts are inserted into the respective ones of the connection grooves and connection insert holes the blade mouthpieces and the stop block mouthpieces can be rotated to lock onto the respective flexible blade arm, the flexible stop block arm and the first and second ends of the flexible center arm.

In another exemplary embodiment the first and second ends of the elongated flat base are bent downward to cause the flexible blade arm and the flexible stop block arm extend upward toward the flexible center arm.

In still another exemplary embodiment the base may further comprise at least one clamp attached to a bottom thereof and configured to clamp to a circumferential rim of a fruit receiving bag or other device, such as a harvesting platform.

In still another exemplary embodiment the base may further comprise a horizontal connection flange disposed at each side of the vertical edge flange, each horizontal connection flange including one clamp of the at least one clamp removably connected thereto.

In yet another exemplary embodiment the first and second stop block mouthpieces can include: a hard core portion in which the groove post and insert post extend therefrom; a soft overmold formed on top of the hard core portion; and a guide to guide a blade to the stop block formed thereon.

In still another exemplary embodiment the first and second blade mouthpieces can include: a hard core portion in which the groove post and insert post extend therefrom; a soft over-mold formed on top of the hard core portion; and an insert to fixedly receive a back of a blade therein.

The foregoing and/or other features and utilities of the present general inventive concept may also be achieved by providing a fruit stem removal apparatus, comprising: an elongated base including a first end bent downward and a second end bent downward; a flexible blade arm attached at a first end thereof to the first downward bent end of the elongated base such that a second end thereof extends at an angle upwards towards a center of the base, the flexible blade arm including a first blade extending outward from the second end thereof; a flexible stop block arm attached at a first end thereof to the second downward bent end of the elongated base such that a second end thereof extends at an angle upwards towards the center of the base, the flexible stop block arm including a first stop block attached to the second end thereof; and an elongated flexible center arm disposed above and in parallel with the elongated base and including: a first end having a second stop block attached thereto to contact an edge of the first blade when the flexible blade arm and the flexible center arm are pressed downward; and a second end having a second blade attached thereto to contact the first stop block when the flexible stop block arm and the flexible center arm are pressed downward.

In an exemplary embodiment, the fruit stem removal apparatus may further comprise a center arm support extending from the elongated base and attached to the flexible center arm to maintain the flexible center arm above and in parallel with the elongated base.

In another exemplary embodiment, the fruit stem removal apparatus may further comprise a first blade mouthpiece attached to the second end of the flexible blade arm and including the first blade extending therefrom; a first stop block mouthpiece attached to the second end of the flexible stop block arm and including the first stop block formed thereon; a second stop block mouthpiece attached to the first end of the flexible center arm and including the second stop block formed thereon; and a second blade mouthpiece attached to the second end of the flexible center arm and including the second blade extending therefrom.

In still another exemplary embodiment, the first and second blade mouthpieces are removable from the flexible blade arm and second end of the flexible center arm by a twisting motion and the first and second stop block mouthpieces are removable from the flexible stop block arm and first end of the flexible center arm by a twisting motion.

In yet another exemplary embodiment, the first and second stop block mouthpieces include a hard core portion and a soft overmold formed on top of the hard core portion, wherein the stop block is formed therebetween.

In still another exemplary embodiment, the first and second blade mouthpieces include a hard core portion and a soft overmold formed on top of the hard core portion, the blade being molded within the hard core portion.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a perspective view of a fruit stem removal apparatus, according to an example embodiment of the present inventive concept.

FIG. 2 illustrates a front view of the fruit stem removal apparatus according to the example embodiment of FIG. 1.

FIG. 3 illustrates a top view of the fruit stem removal apparatus according to the example embodiment of FIG. 1.

FIG. 4 illustrates an exploded view of the fruit stem removal apparatus according to the example embodiment of FIG. 1.

FIG. 5 illustrates a side view of the fruit stem removal apparatus according to the example embodiment of FIG. 1.

FIG. 6A illustrates an unassembled view of a mouthpiece and stop block arm combination of the fruit stem removal apparatus according to the example embodiment of FIG. 1.

FIG. 6B illustrates an unassembled view of a mouthpiece and blade arm combination of the fruit stem removal apparatus according to the example embodiment of FIG. 1.

FIG. 7 illustrates a perspective view of a fruit stem removal apparatus, according to another example embodiment of the present inventive concept.

FIG. 8 illustrates a front view of the fruit stem removal apparatus according to the example embodiment of FIG. 7.

FIG. 9 illustrates an exploded view of the fruit stem removal apparatus according to the example embodiment of FIG. 7.

FIG. 10 illustrates another example embodiment of a fruit stem removal apparatus attachable to an arm sleeve.

FIG. 11 illustrates a perspective rear view of a fruit stem removal apparatus, according to another example embodiment of the present inventive concept.

FIG. 12 illustrates a front view of the fruit stem removal apparatus according to the example embodiment of FIG. 11.

FIG. 13 illustrates a top view of the fruit stem removal apparatus according to the example embodiment of FIG. 11.

FIG. 14 illustrates an exploded rear view of the fruit stem removal apparatus according to the example embodiment of FIG. 11.

FIG. 15A illustrates a top view of an example embodiment of a block mouthpiece used with the fruit stem removal apparatus according to the example embodiment of FIG. 11.

FIG. 15B illustrates a side cross sectional view of the block mouthpiece of FIG. 15A.

FIG. 15C illustrates a perspective view of the block mouthpiece of FIG. 15A.

FIG. 15D illustrates a front view of the block mouthpiece of FIG. 15A.

FIG. 15E illustrates a disassembled view of the block mouthpiece of FIG. 15A.

FIG. 16A illustrates a top view of an example embodiment of a blade mouthpiece used with the fruit stem removal apparatus according to the example embodiment of FIG. 11.

FIG. 16B illustrates a side cross sectional view of the blade mouthpiece of FIG. 16A.

FIG. 16C illustrates a perspective view of the blade mouthpiece of FIG. 16A.

FIG. 16D illustrates a front view of the blade mouthpiece of FIG. 16A.

FIG. 16E illustrates a disassembled view of the blade mouthpiece of FIG. 15A.

The drawings illustrate a few example embodiments of the present inventive concept, and are not to be considered limiting in scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of the lexicographer, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Hereinafter, one or more example embodiments of the present general inventive concept will be described in detail with reference to the accompanying drawings.

Example embodiments of the present general inventive concept are directed to a fruit stem removal apparatus that enables hands-free fruit stem clipping/removal usable with all types of fruits in order to improve efficiency of fruit picking processes.

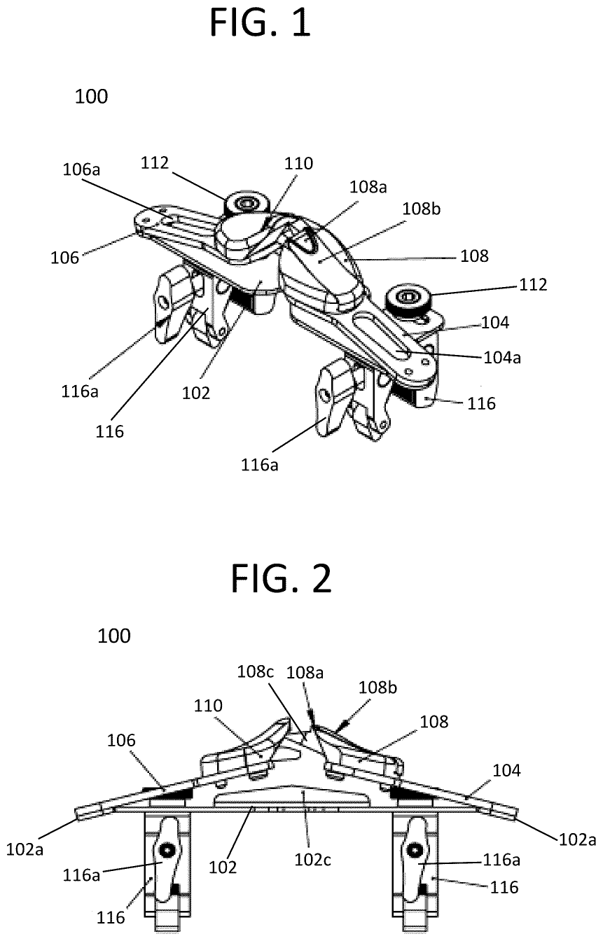

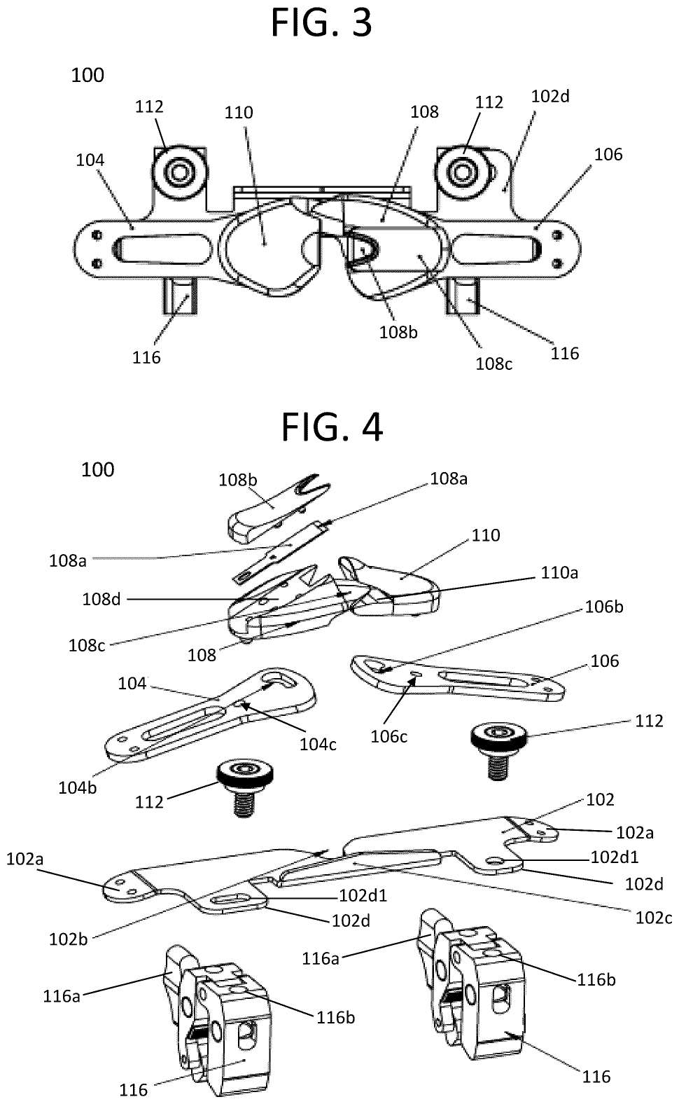

FIG. 1 illustrates a perspective view of a fruit stem removal apparatus 100, according to an example embodiment of the present inventive concept, FIG. 2 illustrates a front view of the fruit stem removal apparatus 100 according to the example embodiment of FIG. 1, and FIG. 3 illustrates a top view of the fruit stem removal apparatus 100 according to the example embodiment of FIG. 1. Referring to FIGS. 1-3, the fruit stem removal apparatus 100 according to this example embodiment includes a base 102 in which all parts attach thereto. The fruit stem removal apparatus 100 can include a first side which provides a flexible blade arm 104 including a blade mouthpiece 108 attached at a first end thereof to house a blade 108a. The blade 108a can be enclosed over the blade mouthpiece 108 by a blade cover 108b. The fruit stem removal apparatus 100 can also include a second side which provides a flexible stop block arm 106 comprising a stop block mouthpiece 110 attached at a first end thereof. The stop block mouthpiece 110 is configured to limit downward movement of the flexible blade arm 104 and blade mouthpiece 108. Further, both mouthpieces 108 and 110 work act to limit downward movement of the other one of the mouthpieces as well as to align the mouthpieces 108 and 110. More specifically, when one of the mouthpieces 108, 110 is pressed downwards, the other one of the mouthpieces 108, 100 will follow by being forced downwards by the one mouthpiece 108,110 being pressed downwards. The blade arm 104 and the stop block arm 106 can be formed of a flexible metal, such as, for example a stainless steel, Ultem®, polyetherimide (PEI), or a polyoxymethylene (POM), which will provide a spring action when pressed downward. In an alternative embodiment the base 102 can be formed of a flexible material and the flexible blade arm 104 and the flexible stop block arm 106 can be integral extensions thereof. In this example embodiment both the flexible blade arm 104 and the flexible stop block arm 106 can be portions of the base 102 which are bent upward at an angle to extend toward the center of the base 102.

As illustrated in FIG. 2, the base 102 can include first and second arm attachment wings 102a. The first and second arm attachment wings 102a are preferably integrally formed with the base 102 to extend from opposite ends of the base 102 and are bent downward from the main body portion of the base 102. The first and second arm attachment wings 102a are configured to attach to a second end of the flexible blade arm 104 and a second end of the flexible stop block arm 106, respectively. The base 102 can be attached to at least one connection clamp 116 via a screw 112, such that the at least one clamp 116 can connect the fruit stem removal apparatus 100 to a picking bag (not illustrated for brevity of the detailed description). The picking bag is used to receive the picked fruit therein after the fruit stem is removed by the fruit stem removal apparatus 100. The base 102 can also include a vertical edge flange 102c, which is bent upward to prevent stems from falling into the picking bag after the stems are removed from the fruit by the blade 108a.

FIG. 4 illustrates an exploded view of the fruit stem removal apparatus 100 according to the example embodiment of FIG. 1. A more detailed description of each of the parts of the fruit stem removal apparatus 100, and operations thereof, is provided below with reference to FIG. 4

Referring to FIG. 4, the base 102 can be made from a flat metal plate, such as, for example stainless steel, or other rigid material. The base 102 can include the first and second downward bent arm attachment wings 102a extending from opposite ends thereof, a stem groove 102b formed at a center portion thereof, a vertical edge flange 102c bent upward, and a horizontal connection flange 102d extending outward and disposed at each side of the vertical edge flange 102c. The first and second arm attachment wings 102a are configured to bend downward such that when the second end of the blade arm 104 and the second end of the stop block arm 106 are attached to respective ones of the first and second arm attachment wings 102a the first ends of the blade arm 104 and the stop block arm 106 will extend upward to form a triangular shape, as illustrated in FIGS. 2 and 4. The second end of the blade arm 104 and the second end of the stop block arm 106 can be attached to the first and second arm attachment wings 102a, respectively, via welding, glue, rivets, or any other equivalent means of attachment which will perform the intended purpose of securing the blade arm 104 and the stop block arm 106 to the base 102. The blade arm 104 and the stop block arm 106 can each include connection grooves 104b, 106b, respectively, and connection inserts 104c, 106c, respectively, for purposes of which are described in more detail below with reference to FIGS. 6A-6B.

FIG. 6A illustrates an unassembled view of a stop block mouthpiece 110 and stop block arm 106 combination of the fruit stem removal apparatus 100, according to the example embodiment of FIG. 1, in order to provide a detailed description of an assembly of the stop block arm 106 to the stop block mouthpiece 110. FIG. 6B illustrates an unassembled view of the blade mouthpiece 108 and blade arm 104 combination of the fruit stem removal apparatus 100, according to the example embodiment of FIG. 1.

Referring to FIGS. 6A and 6B, the connection grooves 104b, 106b are preferably formed to have a wider side and a more narrow side (i.e., kidney shaped), generally referred to as a “rotational slide-and-lock” mechanism, which is described in more detail below. Each of the blade mouthpiece 108 and the stop block mouthpiece 110 can include a mouthpiece groove post 108e, 110e, respectively, and a mouthpiece insert post 108f, 110f, respectively. The mouthpiece groove posts 108e, 110e and the mouthpiece insert posts 108f, 110f are configured to be inserted into the connection grooves 104b, 106b, respectively, and a connection insert 104c, 106c, respectively. More specifically, the mouthpiece groove posts 108e, 110e should be inserted into the wider side of the connection inserts 104c, 106c, respectively. The connection inserts 104c, 106c are designed to have a diameter approximately the same as a diameter of outer ends of the mouthpiece groove posts 108e, 110b. A middle section of the mouthpiece groove posts 108e, 110e have a smaller diameter than the outer ends thereof such that once the mouthpiece groove posts 108e, 110e are inserted into the wider sides of the connection grooves 104b, 106b, respectively and the mouthpiece insert posts 108f, 110f are inserted into the connection inserts 104c, 106c, respectively, the mouthpieces 108 and 110 can be slightly rotated such that the middle section of the mouthpiece groove posts 108e, 110e will tightly fit into the more narrow side of the connection grooves 104b, 106b, respectively, removably securing the mouthpieces 108 and 110 to the respective blade arm 104 and the stop block arm 106. More specifically, middle passages on the connection grooves 104b, 106b can be slightly narrower than the middle section of the groove posts 108e, 110e such that when the groove posts 108e, 110e are inserted into the respective connection grooves 104b, 106b and then rotated there will be a slight resistance due to the narrower passage. After the middle sections of the groove posts 108e, 110e reach the end of the passage of the respective connection grooves 104b, 106b the openings on the connection grooves 104b, 106b can be the same size as the middle sections of the groove posts 108e, 110e to lock the groove posts 108e, 110e in place. With this configuration both mouthpieces 108 and 110 can be replaced with new ones in the case of damage or wear.

Each of the horizontal connection flanges 102d can include a hole 102dl formed therethrough to receive a respective screw 112. After the screws 112 are inserted through respective ones of the holes 102d1 the screws 112 can be threaded into a threaded hole 116b formed in a respective one of the connection clamps 116 to secure the connection clamps 116 to the base 102.

Referring back to FIG. 4, the blade mouthpiece 108 can include a slot 108d extending along a length of a top portion thereof to receive the blade 108a therein and a blade cover 108b to secure the blade 108a to the blade mouthpiece 108. The blade 108a and slot 108d can each include one or more holes therein to receive one or more respective posts extending from the bottom of the blade cover 108b to removably secure the blade 108a and blade cover 108b to the top of the blade mouthpiece 108. Preferably the posts extending from the blade cover 108c are configured to press-fit into respective ones of the holes formed in the blade mouthpiece 108, or can be glued or heat staked, etc. Once the blade mouthpiece 108 and the stop block mouthpiece 110 are secured to the blade arm 104 and stop block arm 106, respectively, a blade mouthpiece alignment protrusion 108c will align with a stop block mouthpiece alignment groove 110a such that when either one of the mouthpieces 108, 110 are pressed down the other one of the mouthpieces 108, 110 will be pressed down synchronously to ensure the two mouthpieces 108,110 always align when a fruit is pushed down on the fruit stem removal apparatus 100. Both upper surfaces of the mouthpieces 108,110 can have a curved shape to guide the “stem bowl” portion of certain fruits so the stem of the fruit will be centered on the fruit stem removal apparatus 100 for an accurate stem cutting by the blade 108a. The upper surfaces of the mouthpieces 108, 110 can be configured to receive the center of the stem area of any types of fruits.

When the blade arm 104 and stop block arm 106 are pushed down by a piece of fruit the corresponding mouthpieces 108 and 110 move toward the base 102 while also moving toward each other to generate a squeeze action therebetween. FIG. 3 illustrates a top view of the fruit stem removal apparatus 100 to illustrate that the two mouthpieces 108, 110 form a funnel shaped opening in the top side of the apparatus, while the other sides of the mouthpieces form a closed condition. With this configuration targeting of the fruit and stem is enabled since a user can easily slide a stem of a fruit into the opening on the top side while a stopping surface is provided on the other side to enable the stems to be cut at the correct place. The opening at the top side can be placed on either side of the fruit stem removal apparatus 100 depending on the preference of the picker. For example, having the opening on the picker side provides better visual cues, while having the opening on the other side can enable more fluid motion while providing less visual cues.

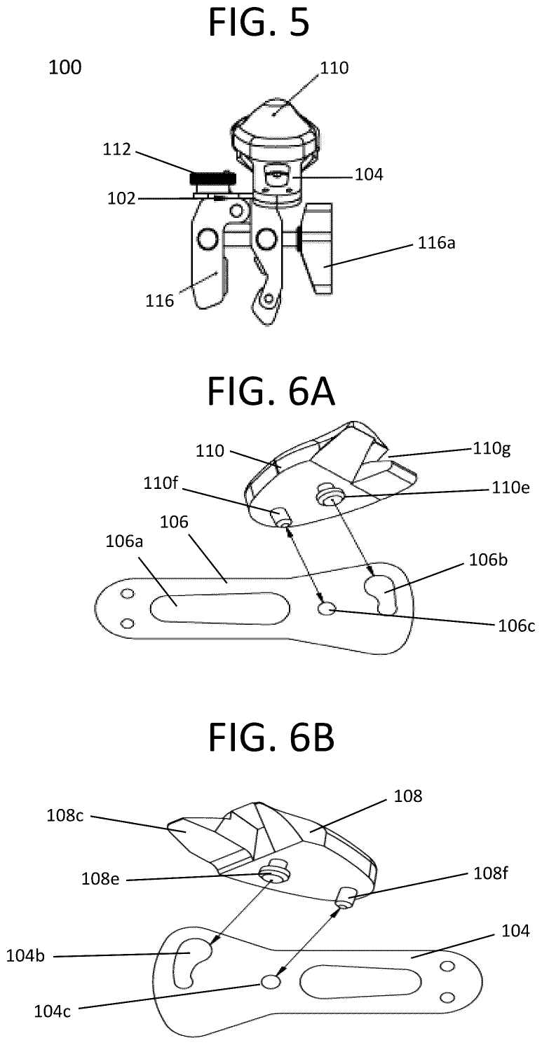

FIG. 5 illustrates a side view of the fruit stem removal apparatus according to the example embodiment of FIG. 1. As illustrated in FIG. 5, the mouthpieces 108, 110 form an inverted “V” shape space directly underneath the cutting blade 108a, which provides for accommodating thicker stems of fruits by preventing the two mouthpieces 108, 110 from squeezing on the stem instead of cutting the stem. It is to be noted that the mouthpieces 108, 110 can be customized to fit any size, shape, surface hardness and/or any other properties of different fruit varieties, without departing from the spirit and scope of the overall present inventive concept as described herein.

Referring back to FIGS. 1-2 and 4, the mouthpieces 108, 110 have a sloping design in the top surfaces to guide the fruit stem during cutting action. As the two mouthpieces 108, 110 close due to the force of a fruit being pushed down on them, the sloping design will push the stem towards the center of the blade 108a to perform an accurate cutting action on the stem. The blade mouthpiece alignment protrusion 108c and the stop block mouthpiece alignment groove 110a cause the two mouthpieces 108, 110 to interlock when pressed down, which causes the cutting blade 108a and the cutting surface within the stop block mouthpiece alignment groove 110a to meet and perform a correct cutting action. Further, the two mouthpieces 108, 110 conform to the shape of the surface around the fruit stems such that when a fruit is pushed with its stem facing down towards the base 102 the surface around the stem will automatically guide the two mouthpieces 108, 110 to slide and close to perform a correct cut of the stem. The design of the mouthpieces 108, 110 also causes a “click” sound when a stem is cut as a result of the sudden contact between the two mouthpieces 108, 110, thus providing feedback to the picker that the stem has been successfully cut. This click sound helps to inform the fruit picker as to whether the fruit requires clipping at all since fruits with short stems will not produce any sound since the stem is too short to be clipped, thus resulting in fruit picking efficiency improvement.

The mouthpieces 108, 110 can be made of a soft material to provide a cushion for the fruit being de-stemmed. For example, the mouthpieces 108, 110 can include an elastomer such as, for example, silicone or rubber molded thereon to prevent fruit skins from damage when placed in contact with the mouthpieces 108, 110.

The cutting blade 108a can have different shapes which will provide the intended purpose of cutting the stems off fruits in which the fruit stem removal apparatus 100 is desired to be used for. Furthermore, depending on the fruit variety and stem characteristics, the thickness, hardness and other properties of the blade 108a can be varied without departing from the spirit and scope of the present inventive concept.

As a result of the positioning of the clamps 116 attached to the fruit stem removal apparatus 100 the stem groove 102b of the base will be positioned to extend past the edge of a picking bag in which it is attached, thus causing the removed stems to drop outside the range of the picking bag. Also, the horizontal connection flange 102d will prevent any removed stems that may not fall through the stem groove 102b from sliding across the surface of the base 102 and falling into the picking bag.

According to another example embodiment of the present inventive concept, the fruit stem removal apparatus 100 may be welded to a metal circumferential ring around the outer perimeter of a picking bag, thus eliminating the requirement of the use of clamps 116 to connect the fruit stem removal apparatus 100 to a fruit picking bag.

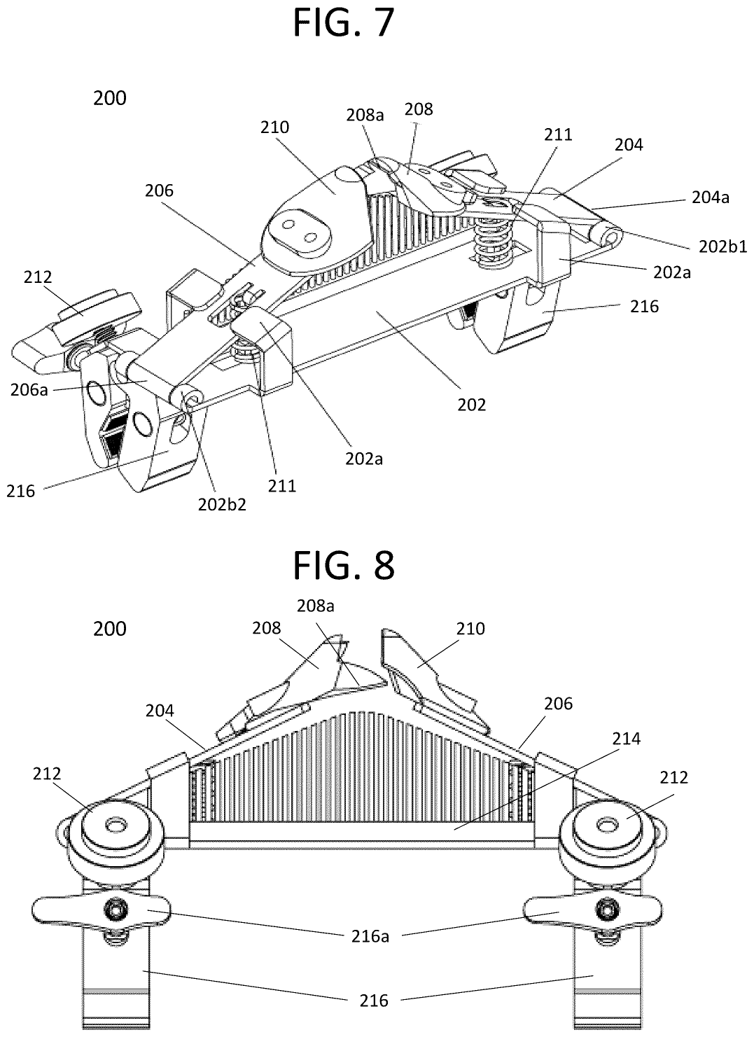

FIG. 7 illustrates a perspective view of a fruit stem removal apparatus 200 according to another example embodiment of the present inventive concept, and FIG. 8 illustrates a front view of the fruit stem removal apparatus 200 according to the example embodiment of FIG. 7. Referring to FIGS. 7 and 8, the fruit stem removal apparatus 200 according to this example embodiment includes a base 202 designed with several variations from the fruit stem removal apparatus 100 according to previous example embodiment. For example, the base 202 according to this example embodiment includes an arm stopper 202a disposed at equidistant positions to the left and to the right from a center portion thereof. Each arm stopper 202a includes a pair of arms which extend upward from opposite sides of the base 202 and then extend inward toward each other. Each arm stopper 202a is configured to limit an upward movement of a respective hinged blade arm 204 and hinged stop arm block 206. The base 202 also can include a first hinge part 202b1 formed at a first end thereof and a second hinge part 202b2 formed at a second end thereof. The first hinged part 202b1 connects to a corresponding hinge part 204a formed on a first end of the blade arm 204 and the second hinge part 202b2 connects to a corresponding hinge part 206a formed on a first end of the hinged blade arm 206.

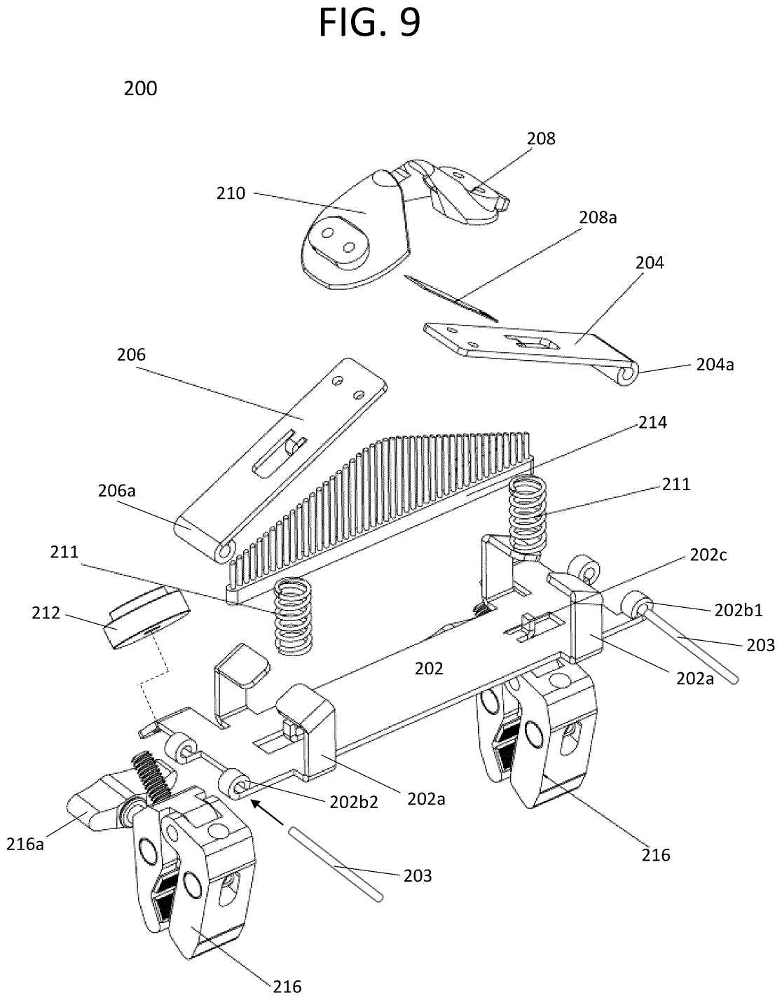

The first hinge part 202b 1 of the base 202 can be connected to the corresponding hinge part 204a of the blade arm 204 with a hinge pin 203 (see FIG. 9) and the second hinge part 202b2 of the base 202 can be connected to the corresponding hinge part 206a with another pin 203 (see FIG. 9). The base 202 can also include a spring engagement part 202c disposed directly under each of the arm stoppers 202a. Each spring engagement part 202c is configured to engage with and retain a corresponding spring 211 to remain seated upright directly under a respective hinged blade arm 204 and hinged stop block arm 206. With these configurations the hinged blade arm 204 will be rotatable between the corresponding arm stopper 202a and the corresponding spring 211 and the hinged stop block arm 206 will be rotatable between the corresponding arm stopper 202a and the corresponding spring 211. The springs 211 will enable both the hinged blade arm 204 and hinged stop block arm 206 to pivot downward when a fruit is pressed against mouthpieces 208 and 210 fixed to second ends of the hinged blade arm 204 and hinged stop block arm 206, respectively. The mouthpieces 208 and 210 can be similar in design to the mouthpieces 108 and 110 according to the previous example embodiment, and therefore will not be described in detail in order to provide brevity to the detailed description herein.

Attached to one side of the base 202 can be a brush 214 to prevent stems from falling into a picking bag in which the fruit stem removal apparatus 200 can be attached thereto with a pair of clamps 216. Each of the clamps 216 can be attach to the fruit stem removal apparatus 200 with a screw type unit 212, which screws into a corresponding threaded hole (not illustrated) formed in each of the clamps 216. The brush 214 is preferably disposed to stand directly adjacent the hinged blade arm 204 and hinged stop block arm 206 as both the hinged blade arm 204 and hinged stop block arm 206 pivot up and down with respect to the base 202.

FIG. 10 illustrates another example embodiment of a fruit stem removal apparatus. In this example embodiment the fruit stem removal apparatus 300 can include a base 302 which can be configured to be attached to an arm sleeve 350. This setup will also provide for a hands-free use of the apparatus 300 itself. The fruit stem removal apparatus 300 can be attached to such an arm sleeve or other similar object via rivets, nut and bolt combinations, or other equivalents means which will perform the intended function of attaching the fruit stem removal apparatus 300 to an arm sleeve or other object. Alternatively, the fruit stem removal apparatus 300 according to this example embodiment can be easily installed onto and removed from an arm sleeve or other object via fabric snaps (with one side fastened onto the base via glue, screws, bolts or rivets, and the other side being fastened to the arm sleeve). Here, when not in use the fruit stem removal apparatus 300 can be removed from the sleeve or other object to provide more comfort for the wearer of the sleeve.

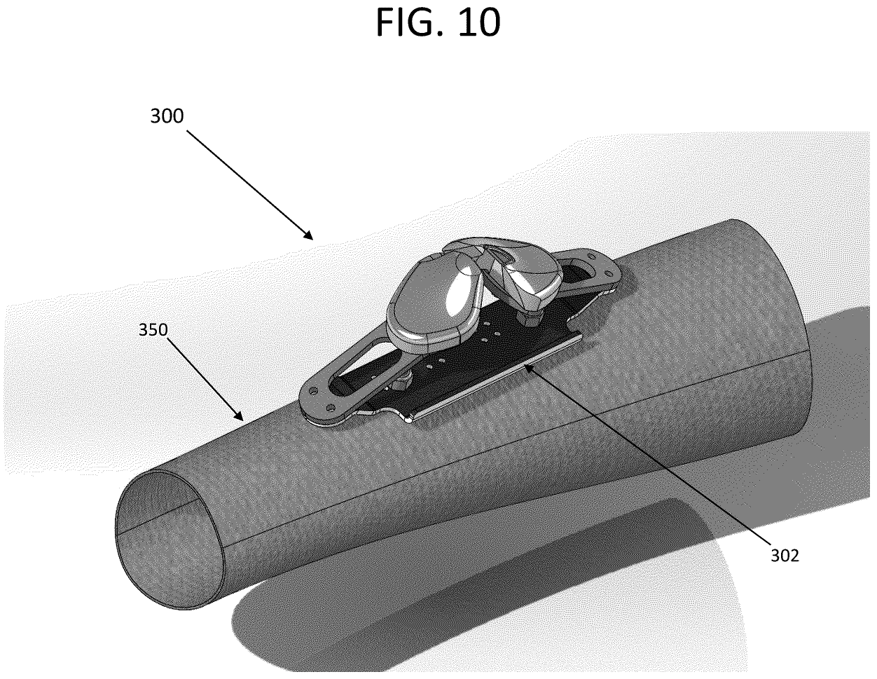

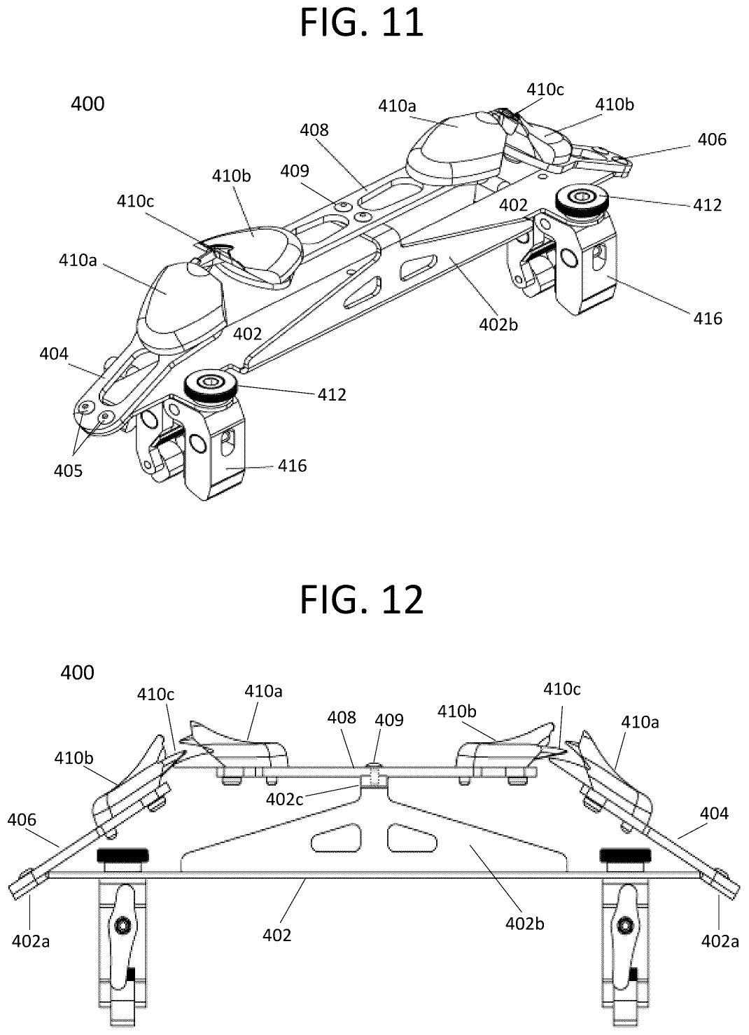

FIG. 11 illustrates a perspective rear view of a fruit stem removal apparatus 400, according to another example embodiment of the present inventive concept. FIG. 12 illustrates a front view of the fruit stem removal apparatus according to the example embodiment of FIG. 11. In the example embodiment illustrated in FIGS. 11 and 12 the fruit stem removal apparatus 400 includes a pair of stem cutting/removing devices. The first stem cutting device can be disposed at a first end of the fruit stem removal apparatus 400 and the second stem cutting device can be disposed at a second (opposite) end of the fruit stem removal apparatus 400. More specifically, the fruit stem removal apparatus 400 can include an elongated base 402 having a base wall 402a extending upward away from a first side of the base 402 at an angle perpendicular thereto and along the first side of base 402. The base wall 402a can be shaped as an upright triangle such that an elongated bottom portion thereof extends along the first side of the base 402. Extending perpendicularly away from a top portion of the triangular base wall 402a can be formed a center arm support 402c. The center arm support 402c is preferably disposed directly above and in parallel with the base 402. The base can be formed of a metal material or other material which is sufficiently rigid to withstand pressures of fruits being pressed against the fruit stem removal apparatus 400.

Still referring to FIGS. 11 and 12, opposite ends of the elongated base 402 can be bent downward to form arm attachment wings 402a such that a first end of a flexible stop block arm 404 can be attached to an upper side of a first arm attachment wing 402a and a first end of a flexible blade arm 406 can be attached to an upper side of a second arm attachment wing 402a opposite to the first arm attachment wing 402a. With the configuration of the first and second arm attachment wings 402a a second end of the stop block arm 404 and a second end of the blade arm 406 will extend upward and toward each other directly above the base 402. Between the second end of the flexible stop block arm 404 and the second end of the flexible blade side arm 406 can be disposed a flexible center arm 408. The flexible center arm 408 can be fixed in place by connecting a center portion thereof to the center arm support 402c such that a first end of the flexible center arm 408 extends toward the second end of the flexible stop block arm 404 and a second end of the flexible center arm 408 extends toward the second end of the flexible blade side arm 406.

Attached to the second end of the flexible stop block arm 404 can be a first stop block mouthpiece 410a and attached to the first end of the center arm 408 can be a first blade mouthpiece 410b. Further, attached to the second end of the flexible blade arm 406 can be a second blade mouthpiece 410b and attached to the second end of the center arm 408 can be a second stop block mouthpiece 410a. With this configuration the first stop block mouthpiece 410a and the first blade mouthpiece 410b combination can be arranged to face each other to remove stems from a piece of fruit while the second stop block mouthpiece 410a and the second blade mouthpiece 410b combination can also be arranged to face each other to remove stems from another piece of fruit, wherein the stems of each piece of fruit can be removed simultaneously or in rapid succession via both hands of a user. As a result of the design of the fruit stem removal apparatus 400 according to the example embodiment of FIGS. 11 and 12, the time required for a fruit picker to pick fruits from a tree or bush and remove the stems from picked fruits can be significantly decreased as compared with other stem removal devices since both hands of the fruit picker can simultaneously pick the fruits and press the fruits against the first stop block mouthpiece 410a and first blade mouthpiece 410b combination and the second stop block mouthpiece 410a and second blade mouthpiece 410b combination to cut stems from two pieces of fruit simultaneously or in rapid succession.

Another advantage of the fruit stem removal apparatus 400 according to the example embodiment illustrated in FIGS. 11 and 12 is that each cutting device (combination of a stop block mouthpiece 410a and a blade mouthpiece 410b) can be slightly angled to provide a neutral cutting position for each hand of a user, resulting in the work being required for each wrist of the user to be minimal. This slightly angled positioning of the pair of cutting devices can be obtained as a result of the upward angled stop block side arm 404 and the upward angled blade side arm 406, which places the first stop block mouthpiece 410a and the second blade mouthpiece 410b and the same upward angle as the corresponding stop block side arm 404 and blade side arm 406.

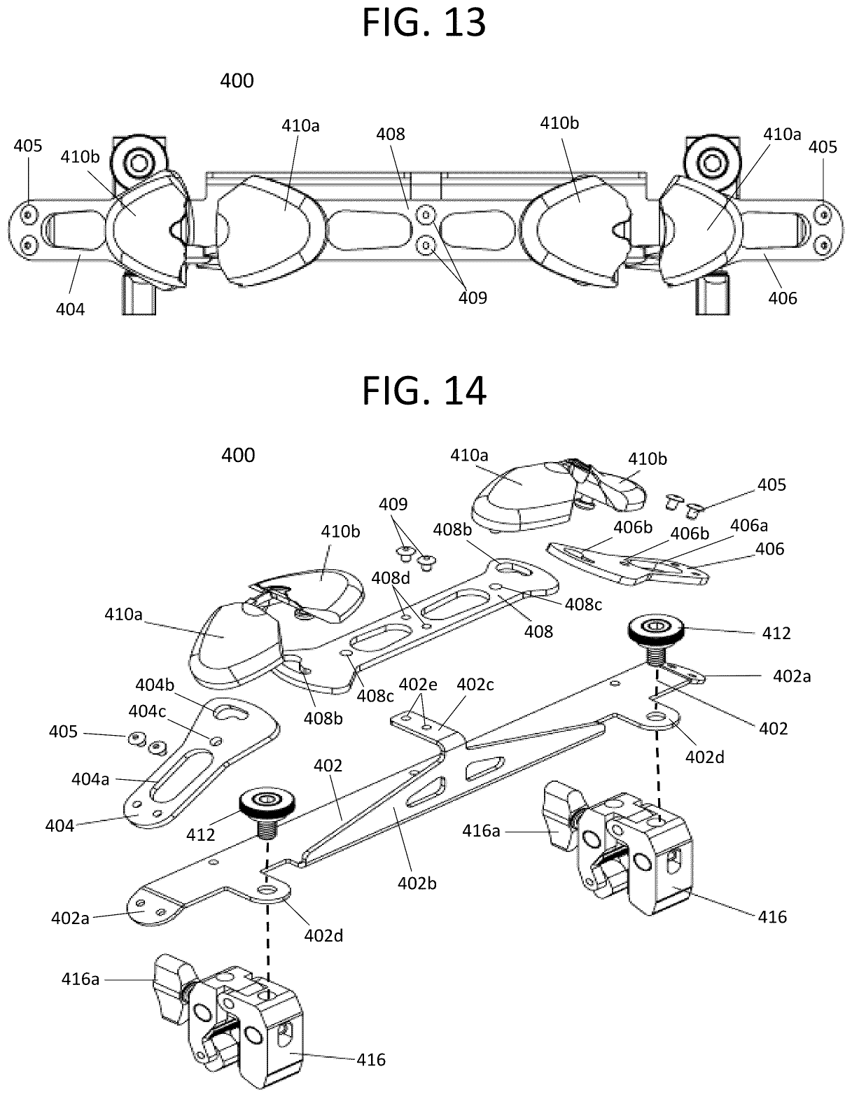

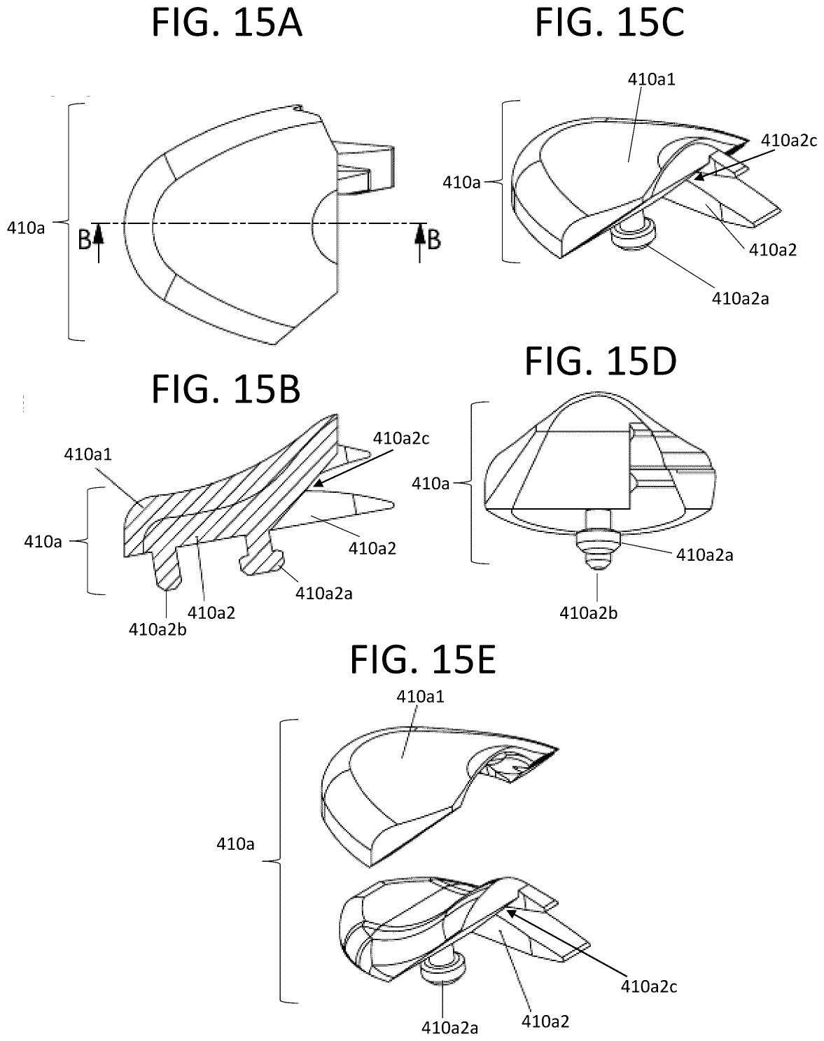

FIG. 13 illustrates a top view of the fruit stem removal apparatus 400 according to the example embodiment of FIGS. 11 and 12. As illustrated in FIG. 13 the first end of the flexible stop block arm 404 can be attached to an upper side of the first arm attachment wing 402a with a pair of rivets 405 and the first end of the flexible blade arm 406 can be attached to an upper side of a second arm attachment wing 402a with another pair of rivets 405. Alternatively, the first end of the flexible stop block arm 404 can be attached to the first arm attachment wing 402a by welding or with screws or other equivalent means, and the first end of the flexible blade arm 406 can also be attached to an upper side of the second arm attachment wing 402a by welding or with screws or other equivalent means. The flexible center arm 408 can be attached, at a center thereof, to the center arm support 402c with a pair or rivets 409 or can be attached to the center arm support 402c by welding or with screws, or other equivalent attachment means. The center arm 408 can be formed of a flexible metal to enable the attached first blade mouthpiece 410b and second stop block mouthpiece 410a to slightly pivot downward toward the corresponding first stop block mouthpiece 410a and second blade mouthpiece 410b. It is to be noted that the flexible stop block arm 404 and the flexible blade arm 406 are also formed of a material sufficiently flexible to bend enough to bring the first stop block mouthpiece 410a and the second blade mouthpiece 410b toward the first blade mouthpiece 410b and the second stop block mouthpiece 410a, respectively, so that the blade 410c within the first and second blade mouthpieces 410b can be forced against blade stops 410a2c (described in more detail below with reference to FIGS. 15B-15E) of the corresponding stop block mouthpieces 410a to cut a stem on a piece of fruit.

FIG. 14 illustrates an exploded rear view of the fruit stem removal apparatus 400 according to the example embodiment of FIGS. 11 and 12. As illustrated in FIG. 14, the base 402 can also include a pair of horizontal connection flanges 402d extending outward from the first side of the base 402. The horizontal connection flanges 402d can be positioned such that the base wall 402b is disposed between the pair of horizontal connection flanges 402d. Each of the horizontal connection flanges 402d can include a hole extending therethrough to receive a corresponding threaded thumb screw 412 inserted therethrough from a top side thereof. Alternatively, each of the horizontal connection flanges 402d can include other equivalent attachment means, such as, for example, bolts attached thereto to be bolted to objects such as hard rims of picking bags or harvest platforms. At a bottom side of the horizontal connection flanges 402d can be disposed a corresponding crab clamp 416 with a threaded hole extending into a top side thereof to threadedly receive the threaded thumb screw 412 in order to secure the crab clamps 416 to an underside of the base 402. The crab clamps 416 can then be clamped to a bag to receive picked and de-stemmed fruit therein. The crab clamps 416 can be secured to a circumference of a fruit receiving bag by seating the clamp 416 over the circumference of the bag and then tightening crab clamp screws 416a to close the crab clamps 416. Fruit bags are well known to include a rigid wire or rigid hard plastic rim around a circumference of the opening to help maintain such bags in an open position.

It is to be noted that when the base 402 (and therefore the entire fruit stem removal apparatus 400) is clamped to a fruit receiving bag to receive de-stemmed fruit therein the base wall 402b is configured to be disposed in an approximately vertical position to prevent the removed stems of the fruit from falling into the de-stemmed fruit receiving bag. This configuration is achieved by clamping the crab clamps 416 to circumferential rim of the bag such that the base wall 402b is positioned above an inner circumference of the bag to prevent clipped stems from sliding past the base wall 402b and into the bag. As a result of this configuration the clipped stems will be guided to slide off the base 402 at the side opposite the side in which the base wall 402b is disposed, which is the side of the base 402 that is disposed outside of the circumference of the bag, hence preventing the cut stems from falling into the fruit receiving bag

Still referring to FIG. 14, the stop block arm 404 can include a connection groove 404b and a connection insert hole 404c formed therethrough and the blade arm 406 can include a connection groove 406b and a connection insert 406c formed therethrough. The center arm 408 can include a connection groove 408b formed therethrough at a position adjacent to each of the opposite ends thereof and a connection insert hole 408c formed therethrough between respective ones of the connection grooves 408b and the center thereof. At the center portion of the center arm 408 can be formed a pair of holes 408d to receive rivets 409 therethrough to attach the center arm 408 to the center arm support 402c, which can also include a pair of holes 402e formed therethrough to receive the rivets 409.

FIGS. 15A through 15E illustrate detailed features of the block mouthpiece 410a. FIG. 15A illustrates a top view of the block mouthpiece 410a. FIG. 15B illustrates a side cross-sectional view of the block mouthpiece 410a. Referring to FIG. 15B, the block mouthpiece 410a can include a core 410a2 made of a hard plastic material. The core 410a2 can include a groove post 410a2a extending downward from a bottom portion thereof and an insert post 410a2b also extending downward from the bottom portion. FIG. 15C illustrates a perspective view of the block mouthpiece 410a, FIG. 15D illustrates a front view of the block mouthpiece 410a, and FIG. 15E illustrates disassembled view of the block mouthpiece 410a.

Referring to FIGS. 15B-15C and 15E, a soft overmold 410al can be attached to a top surface of the core 410a2 to provide a soft feel when a user presses down on the block mouthpiece 410a. The soft overmold 410al can be formed of a rubber material, or other equivalent material which will provide a soft touch to prevent bruising of fruit when pressing the fruit against the mouthpieces 410a and 410b. The groove post 410a2a can be inserted into the connection groove 404b of the stop block arm 404 while the insert post 410a2b is inserted into the connection insert hole 404c of the stop block arm 404. Once the groove post 410a2a and the insert post 410a2b are inserted into the connection groove 404b and the connection insert hole 404c, respectively, the block mouthpiece 410a can be slightly twisted to lock the groove post 410a2a into the connection groove 404b. Similarly, the groove post 410a2a of a second stop block mouthpiece 410a can be inserted into one of the connection grooves 408b of the center arm 408 while the insert post 410a2b of the second stop block mouthpiece 410a is inserted into one of the connection insert holes 408c of the center arm 408. It is to be noted that the second stop block mouthpiece 410a should be connected to the end of the center arm 408 which is facing the blade arm 406 and not the stop block arm 404. Once the groove post 410a2a and the insert post 410a2b of the second stop block mouthpiece 410a are inserted into the connection groove 408b and the connection insert hole 408c, respectively, the second stop block mouthpiece 410a can be slightly twisted to lock the groove post 410a2a into the connection groove 408b, thus locking the second stop block mouthpiece 410a to the center arm 408.

Referring to FIGS. 15B and 15E, the stop block mouthpiece 410a includes a blade stop 410a2c configured to receive therein a blade 410c extending from the blade mouthpiece 410b such that the blade 410c will press against the blade stop 410a2c and cut a stem on a piece of fruit.

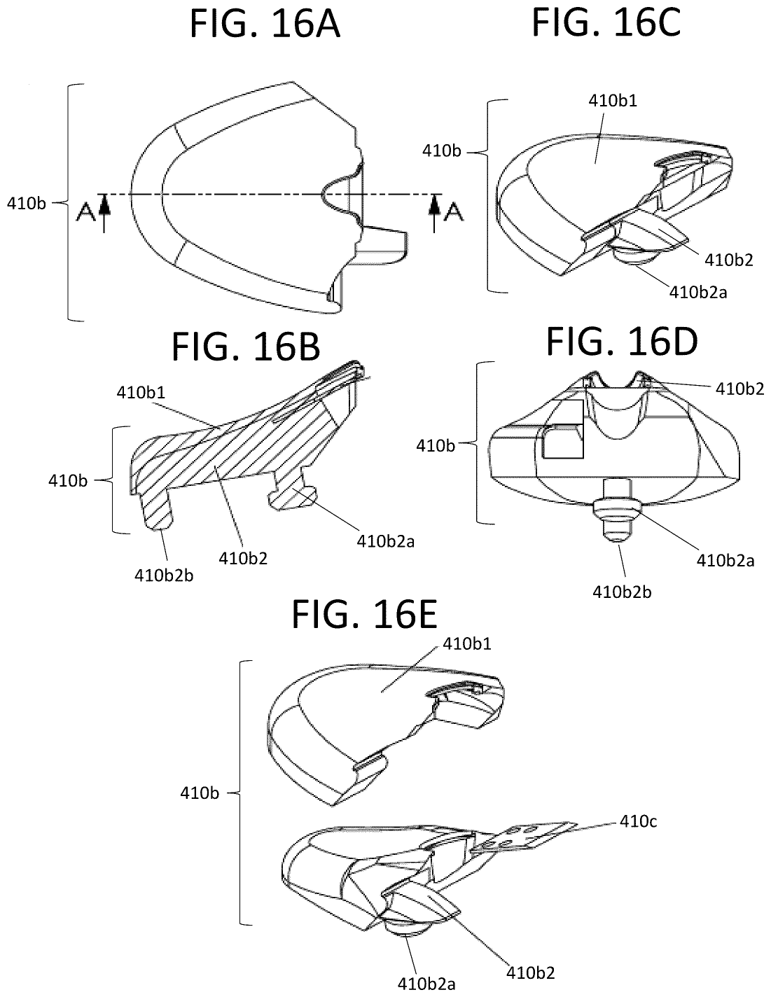

FIGS. 16A through 16E illustrate detailed features of the blade mouthpiece 410b. FIG. 16A illustrates a top view of the blade mouthpiece 410b. FIG. 16B illustrates a side cross-sectional view of the blade mouthpiece 410b. Referring to FIG. 16B, the blade mouthpiece 410b can include a core 410b2 made of a hard plastic material. The core 410b2 can include a groove post 410b2a extending downward from the bottom thereof and an insert post 410b2b extending downward from the bottom thereof. FIG. 16C illustrates a perspective view of the blade mouthpiece 410b, FIG. 16D illustrates a front view of the blade mouthpiece 410b, and FIG. 16E illustrates disassembled view of the blade mouthpiece 410b. A soft overmold 410b1 can be attached to the top surface of the hard core 410b2 to provide a soft surface to prevent bruising of fruit when pressed down on the blade mouthpiece 410b. The groove post 410b2a can be inserted into the connection groove 406b of the blade arm 406 while the insert post 410b2b is inserted into the connection insert hole 406c of the blade arm 406. Once the groove post 410b2a and the insert post 410b2b are inserted into the connection groove 406b and the connection insert hole 406c, respectively, the blade mouthpiece 410b can be slightly twisted to lock the groove post 410b2a into the connection groove 406b, thus locking the blade mouthpiece 410b to the blade arm 406. Similarly, the groove post 410b2a of a second blade mouthpiece 410b can be inserted into the second connection groove 408b of the center arm 408 while the insert post 410a2b of the second stop block mouthpiece 410a is inserted into the second connection insert hole 408c of the center arm 408. Once the groove post 410a2a and the insert post 410a2b of the second stop block mouthpiece 410a are inserted into the connection groove 408b and the connection insert hole 408c, respectively, the second blade mouthpiece 410b can be slightly twisted to lock the groove post 410b2a into the connection groove 408b, thus locking the second blade mouthpiece 410b to the center arm 408 such that the second blade mouthpiece 410b faces the first stop block mouthpiece 410a connected to the block arm 404.

The blade mouthpiece 410b can also include a thin semicircular layer of rubber 410b2 directly above the blade 410c, which is provided to prevent a user's hands from being cut by the blade 410c. In the example embodiment illustrated in FIG. 16E a rear portion of the blade 410c itself is preferably molded within the plastic hard core 410b2, thus eliminating the need for subsequent assembly of the blade to the blade mouthpiece 410b. Alternatively, the plastic hard core 410b2 portion of the blade mouthpiece 410b can be configured such that blades 410c can be installed/inserted therein.

Referring back to FIG. 12, once the first and second stop block mouthpieces 410a are connected to the block arm 404 and one end of the center arm 408, respectively, and the first and second blade mouthpieces 410b are connected to the blade arm 406 and opposite end of the center arm 408, respectively, the fruit stem removal apparatus 400 can be operated to remove stems from two pieces of fruit simultaneously. More specifically, a stem extending from a first piece of fruit can be placed between the first stop block mouthpiece 410a and the first blade mouthpiece 410b while a stem from another piece of fruit can be placed between the second stop block mouthpiece 410a and the second blade mouthpiece 410b. Then both pieces of fruit can be pressed downward against the corresponding stop block mouthpiece 410a and blade mouthpiece 410b pair, which will cause the block arm 404 and the blade arm 406 to flex downward such that the blades 410c disposed in each of the blade mouthpieces 410b will press against the corresponding blade stop 410a2c and cut the stems off the fruit.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A fruit stem removal apparatus, comprising:
an elongated base including a first end and a second end and an upward extending wall along one side thereof, the wall including an arm support extending from a top portion thereof over the elongated base;
a flexible center arm connected to the arm support such that the center arm is disposed above and in parallel with the elongated base, a first end of the center arm including a first blade extending therefrom and a second end of the center arm including a first stop block attached thereto to receive an end of a blade;
a flexible stop block arm attached at a first end to the first end of the elongated base such that the flexible stop block arm extends at an angle upwards towards the blade attached to the center arm, the stop block arm including a second stop block to receive an end of the first blade extending from the center arm when the flexible stop block arm and flexible center arm are pressed downward toward the base; and
a flexible blade arm attached at a first end thereof to the second end of the base such that the flexible blade arm extends at an angle upwards toward the first stop block attached to the second end of the center arm, the blade arm including a second blade extending therefrom which becomes pressed against the first stop block attached to the center arm when the flexible blade arm and flexible center arm are pressed downward toward the base.

2. The fruit stem removal apparatus according to claim 1, further comprising:
a first blade mouthpiece attached to the first end of the center arm, the first blade mouthpiece including the first blade extending therefrom;
a first stop block mouthpiece attached to the second end of center arm, the first stop block mouthpiece including the first stop block formed thereon;
a second stop block mouthpiece attached to the second end of the flexible stop block arm and including the second stop block disposed thereon; and
a second blade mouthpiece attached to the second end of the flexible blade arm, the second blade mouthpiece including the second blade extending therefrom.

3. The fruit stem removal apparatus according to claim 2, wherein:
the flexible center arm includes a connection groove and a connection insert hole formed therethrough at the first and second ends thereof;
the flexible blade arm and the flexible stop block arm include a connection groove and a connection insert hole formed therein; and
the first and second blade mouthpieces and the first and second stop block mouthpieces each include a groove post and an insert post to be inserted into respective ones of the connection grooves and connection insert holes of the flexible blade arm, the flexible stop block arm and the first and second ends of the center arm, respectively, such that after the groove posts and insert posts are inserted into the respective ones of the connection grooves and connection insert holes the blade mouthpieces and the stop block mouthpieces can be rotated to lock onto the respective flexible blade arm, the flexible stop block arm and the first and second ends of the center arm.

4. The fruit stem removal apparatus according to claim 3, wherein the first and second ends of the elongated flat base are bent downward to cause the flexible blade arm and the flexible stop block arm to extend upward toward corresponding ends of the center arm.

5. The fruit stem removal apparatus according to claim 4, wherein the base further comprises at least one clamp attached to a bottom thereof and configured to clamp to a circumferential rim of a fruit receiving bag.

6. The fruit stem removal apparatus according to claim 5, wherein the base further comprises:
a horizontal connection flange disposed at each side of the vertical edge flange, each horizontal connection flange including one clamp of the at least one clamp removably connected thereto.

7. The fruit stem removal apparatus according to claim 3, wherein the first and second stop block mouthpieces include:
a hard core portion in which the groove post and insert post extend therefrom;
a soft overmold formed on top of the hard core portion; and
a guide to guide a blade to the stop block formed thereon.

8. The fruit stem removal apparatus according to claim 7, wherein the first and second blade mouthpieces include:
a hard core portion in which the groove post and insert post extend therefrom;
a soft overmold formed on top of the hard core portion; and
an insert to fixedly receive a back of a blade therein.

9. A fruit stem removal apparatus, comprising:
an elongated base including a first end bent downward and a second end bent downward;
a flexible blade arm attached at a first end thereof to the first downward bent end of the elongated base such that a second end thereof extends at an angle upwards towards a center of the base, the flexible blade arm including a first blade extending outward from the second end thereof;
a flexible stop block arm attached at a first end thereof to the second downward bent end of the elongated base such that a second end thereof extends at an angle upwards towards the center of the base, the flexible stop block arm including a first stop block attached to the second end thereof; and
an elongated flexible center arm disposed above and in parallel with the elongated base and including:
a first end having a second stop block attached thereto to contact an edge of the first blade when the flexible blade arm and the first end thereof are pressed downward; and
a second end having a second blade attached thereto to contact the first stop block when the flexible stop block arm and the second end thereof are pressed downward.

10. The fruit stem removal apparatus according to claim 9, further comprising:
a center arm support extending from the elongated base and attached to the flexible center arm to maintain the center arm above and in parallel with the elongated base.

11. The fruit stem removal apparatus according to claim 9, further comprising:
a first blade mouthpiece attached to the second end of the flexible blade arm and including the first blade extending therefrom;
a first stop block mouthpiece attached to the second end of the flexible stop block arm and including the first stop block formed thereon;
a second stop block mouthpiece attached to the first end of the flexible center arm and including the second stop block formed thereon; and
a second blade mouthpiece attached to the second end of the flexible center arm and including the second blade extending therefrom.

12. The fruit stem removal apparatus according to claim 11, wherein the first and second blade mouthpieces are removable from the flexible blade arm and second end of the flexible center arm by a twisting motion and the first and second stop block mouthpieces are removable from the flexible stop block arm and first end of the flexible center arm by a twisting motion.

13. The fruit stem removal apparatus according to claim 11, wherein the first and second stop block mouthpieces include a hard core portion and a soft overmold formed on top of the hard core portion, wherein the stop block is formed therebetween.

14. The fruit stem removal apparatus according to claim 13, wherein the first and second blade mouthpieces include a hard core portion and a soft overmold formed on top of the hard core portion, the blade being molded within the hard core portion.

15. A dual action fruit stem removal apparatus, comprising:
an elongated base including a first end and a second end;
a flexible blade arm connected to and extending from the first end of the elongated base and including a first blade extending outward from a distal end thereof;
a flexible stop block arm connected to and extending from the second end of the elongated base and including a first stop block extending outward from a distal end thereof; and
an elongated flexible center arm disposed above and in parallel with the elongated base and including a second stop block attached thereto to contact the first blade when the flexible blade arm and the second stop block are pressed downward and a second end having a second blade attached thereto to contact the first stop block when the flexible stop block arm and the second blade are pressed downward.
